(19) United States
(12) Patent Application Publication
(10) Pub. No.: US 2013/0019516 A1
(43) Pub. Date: Jan. 24, 2013

(54) Bank Buddy Fishing Pole and Rod Support

(71) Applicant: James Sherrod, New Caney, TX (US)

(72) Inventor: James Sherrod, New Caney, TX (US)

(21) Appl. No.: 13/549,298

(22) Filed: Jul. 13, 2012

Related U.S. Application Data
(60) Provisional application No. 61/572,313, filed on Jul. 13, 2011.

(51) Int. Cl. A01K 97/10

(52) U.S. Cl. 43/21.2

(57) ABSTRACT

The invention provides a specially designed aid for children as well as adults who have difficulty holding a fishing rod for an extended period of time. The Bank Buddy is a mounting brace designed to secure one or more poles in a stable position in a hands free manner. Fabricated of a durable metal material, the Bank Buddy comprises a series of tubular components that offer a stable formation when assembled.

### CLAIM OF PRIORITY

This patent application claims priority under 35 USC 119 (e) (1) from U.S. Provisional Patent Application Ser. No. 61/572,313 filed Jul 13, 2011, of common inventorship herewith entitled, “Bank Buddy.”

### FIELD OF THE INVENTION

The present invention pertains to the field of fishing accessories, and more specifically to the field of fishing rod supporting equipment.

### BACKGROUND OF THE INVENTION

The prior art has put forth several designs for fishing rod holders and carriers. Among these are:

U.S. Pat. No. 5,400,996 to Michael Drish describes a portable fishing pole support holder that includes support arms for holding the fishing pole to a variety of elevated operable positions. Legs support the holder in a standing position. Collapsing and locking devices provide easy transport and secure storage.

U.S. Pat. No. 4,479,322 to Richard A. Koppel describes a fishing rod holder for carrying rods that is like a briefcase. The holder carries one to two fishing rods. When opened into its holder position, the holder supports fishing rods at an angle from a horizontally oriented base. This base functions as a bait preparation area.

U.S. Pat. No. 3,701,504 to Virgle L. Woods and LaVerne Readus describes a collapsible portable rack for supporting a series of fishing poles. The rack comprises an inverted U shaped frame with supports for a pole or rod which is designed to anchor the butt ends of the poles to the frame. This anchor to a frame prevents losing a pole to a strike by a fish, yet it enables a fisherman to remove the pole immediately to insure hooking the fish.

None of these prior art references describe the present invention.

### SUMMARY OF THE INVENTION

It is an object of the present invention to provide an improved hands free mounting system for fishing rods.

### BRIEF DESCRIPTION OF THE DRAWINGS

FIG. 1 is a top perspective view showing a metal frame and structure in the fully assembled position.

FIG. 2 is a smaller version of the top perspective view showing a metal frame and structure with a support rod not fully in place.

FIG. 3 is a top perspective view showing a metal frame and structure in the fully assembled position shown supporting two fishing rods.

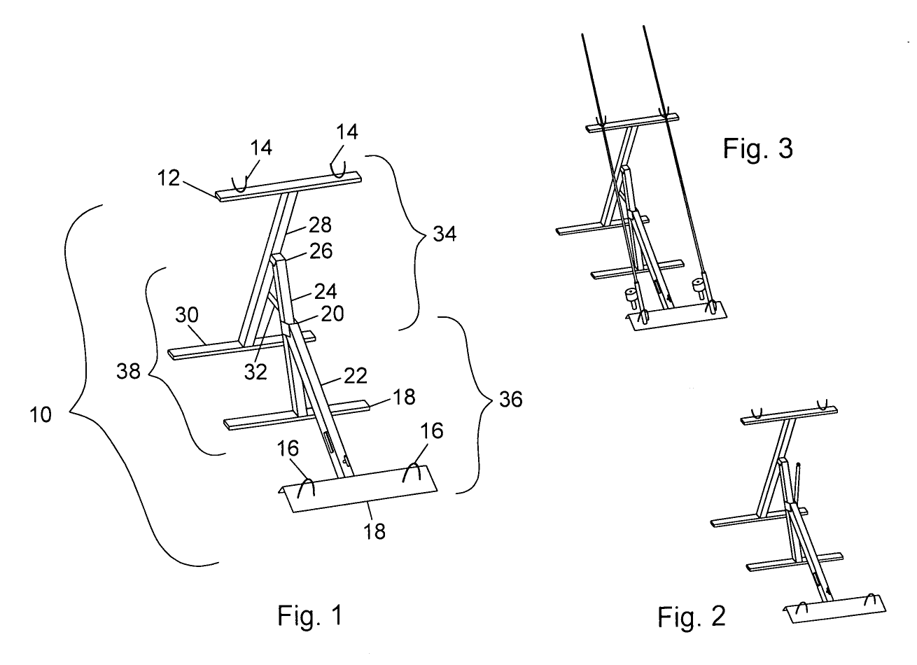

### DETAILED DESCRIPTION OF THE INVENTION

Fishing is a most beloved s and popular sports with more participants than golfing and tennis combined. Most people remember the first time their father or grandfather took them fishing. Reveling in the quality time spent in the beautiful outdoors with a respected adult, kids are excited by luring an unsuspecting fish with their pole and bait. A sudden jerk signifies a nibble on a line, a tense downward pull a hook has found its mark, and a frenzied reel-in of the line finds the prize swaying from the other end. The art are fishing is challenging. Keeping a firm grip on the fishing pole or rod is daunting to beginning anglers. It is common to drop the elongated fishing rod to the ground or into the water accidentally. Initiates to the sport easily lose patience while waiting for an elusive bite, and quickly grow weary of continuously holding on to the pole.

The present invention, hereinafter referred to as the Bank Buddy Fishing Pole and Rod Support, or simply Bank Buddy, is a specially designed aid for children as well as adults who have difficulty holding a fishing rod for an extended period of time. The Bank Buddy is a mounting brace 10 designed to secure one or more poles in a stable position in a hands free manner. Fabricated of a durable metal material, the Bank Buddy comprises a series of tubular components that offer a three parallel support base formation when assembled. The Bank Buddy configuration is manufactured with a selection of metal that includes approximately one inch sixteen gauge metal tubing, one quarter flat bars, one eighth flat bars, and a one quarter inch by one by one inch angle iron. The top cross bar 12 of the present invention comprises an approximate one quarter inch flat top support bar 12 that contains two U loops 14 extending upward. These two U loops 14 serve as the resting spot for distal ends of two fishing rods. At the base 18 of the back support member 36, companion U loops 16 stabilize the proximal ends of poles. The remaining bars serve as a back support member 36, forming a base 18, a perpendicular member 22 which attaches to the center support member 38; the center support member comprises a base 18 and a perpendicular member 24, and the front support member comprises a base 30, a perpendicular member 28 and a top cross bar 12; and the base 18 of the back support member 26 is equipped with U loops 16 to hold the proximal end of one or more fishing poles, and wherein the perpendicular member 22 of back support 36 is attached to the perpendicular member 24 of the center support member 38 at a swivel joint 20 near the center of the perpendicular member 24 of the center support member 38, and the end of the center support member 38 is attached to the perpendicular member 28 of the front support member 34 at a swivel joint 26, and the top cross bar 12 of the front support is equipped with U loops 14 for receiving one or more fishing poles.

Attachment of these three components facilitates secure stability of the present invention on surfaces such as a river bank, a lake shore, wooden decks and piers.

Front support member 34 comprises a front base 30, perpendicular member 28 and a top cross support bar 12.

Front support member 34 forms the form of a letter “I”. Center support and rear support form the form of a letter “T”.

Each component is joined together with swivel mounted hinges 20, 26, allowing the Bank Buddy to be expanded and contracted as needed. Brace 32 adds stability to the angle formed by T member 24 and front perpendicular member 28.

Installation and use of the Bank Buddy is very simple and straightforward. The user takes a compacted Bank Buddy and their fishing gear to a beach front, river deck, or lake shore. Once reaching the fishing destination, the user unfolds the device and secures the base 18 to the sand, ground, deck or pier. With the Bank Buddy in place, the fisherman rests the proximal end of a pole or handle inside a base U loop 16 and inserts the pole or rod top end onto the top support bar 12 resting on the U loop 14. The fisherman baits the hook and extends the line into the water and sits back, relaxes and waits for a fish to bite.

Eliminating the need to constantly hold on to a pole while waiting for a bite, this handy mounting system keeps the rod securely in place for hours at a time. This durable bracing system keeps a fish from jerking a rod free from the hand of an angler. Lightweight and compactable, the Bank Buddy transports easily, along with standard fishing gear. The minimal components that comprise the Bank Buddy ensure that this clever fishing aid is installed and removed in a matter of seconds. Fabricated of durable, high quality materials, the present invention product withstands years of continued use.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A hands free mounting system for fishing rods, comprising: a mounting brace to secure one or more poles in a stable position in a hands free manner comprising a back support in the form of letter “T”, a center support in the form of a letter “T” and a front support in the form of a letter “I” wherein the bases of the three support members form a three parallel support base formation when assembled, and wherein the back support comprises a base and a perpendicular member; the center support member comprises a base and a perpendicular member, and the front support member comprises a base, a perpendicular member and a top cross bar; and the base of the back support member is equipped with U loops to hold the proximal end of one or more fishing poles, and wherein the perpendicular member of back support is attached to the perpendicular member of the center support member at a swivel joint near the center of the perpendicular member of the center support member, and the end of the center support member is attached to the perpendicular member of the front support member at a swivel joint, and the top cross bar of the front support is equipped with U loops for receiving one or more fishing poles.

2. The mounting system of claim 1 comprising approximately one inch sixteen gauge metal tubing, one quarter flat bars, one eighth flat bars, and a one quarter inch by one by one inch angle iron.

3. The mounting system of claim wherein the top cross bar comprises an approximate one quarter inch flat top support bar that contains two U loops extending upward.
